(19) United States
(12) Patent Application Publication
(10) Pub. No.: US 2021/0352977 A1
(43) Pub. Date: Nov. 18, 2021

(54) FACE RECOGNITION HIGH TRANSPARENCY FOOD-GRADE SILICONE REUSABLE MASK

(71) Applicant: SDL TECHNOLOGY CO.,LTD., QinZhou (CN)

(72) Inventor: Tak Nam LIU, QinZhou (CN)

(21) Appl. No.: 17/035,800

(22) Filed: Sep. 29, 2020

(30) Foreign Application Priority Data
May 12, 2020 (CN) 202010397717X

(51) Int. Cl. A41D 13/11; A62B 23/02

(52) U.S. Cl. CPC A41D 13/113; A62B 23/025; A41D 13/1161

(57) ABSTRACT

The present application provides a face recognition high transparency food-grade silicone reusable mask, comprising a silicone face piece, a breathing part and a tightening part, wherein the breathing part is arranged at a position of the mouth and nose, two ends of the tightening part are respectively fixed onto two opposite edges of the silicone face piece.

### CROSS REFERENCE TO RELATED APPLICATION

The present application claims priority to China patent application No. 202010397717.X, entitled “face recognition high transparency food-grade silicone reusable mask”, filed on May 12, 2020, the entire content of which is incorporated herein by reference.

### TECHNICAL FIELD

The present application relates to the field of epidemic prevention, and in particular to a face recognition high transparency food-grade silicone reusable mask.

### BACKGROUND

The 2019 novel coronavirus was named 2019-nCoV by the World Health Organization on Jan. 12, 2020 and was named SARS-CoV-2 by the International Committee on Taxonomy of Viruses on Feb. 11, 2020. The main transmission channels of novel coronavirus are respiratory droplet transmission and contact transmission, and surgical medical masks (referred to as disposable masks) are the main means to prevent novel coronavirus. In some epidemic countries, such as China, Italy, Spain, the United States and other countries, wearing disposable masks has become a compulsory means of epidemic prevention.

For disposable masks, they need to be replaced every 2-4 hours, which greatly increases the use thereof, leading to a surge in the demand for masks. Moreover, for disposable masks, most positions thereof play an auxiliary role, only the positions of the mouth and nose are very effective positions, so the existing disposable masks have a high cost of use.

### SUMMARY

The embodiment of the present application provides a face recognition high transparency food-grade silicone reusable mask, which can replace the part of the mask by replacing parts thereof, thus reducing the use cost of the mask, and the mask has facial recognition function, which can avoid a mixing use of the mask and improve the safety.

The first embodiment of the present application provides a face recognition high transparency food-grade silicone reusable mask, which comprises a silicone face piece, a breathing part and a tightening part, wherein the breathing part is arranged at a position corresponding to the mouth and nose, two ends of the tightening part are respectively fixed onto two opposite edges of the silicone face piece.

The embodiment of the present application has the following beneficial effects:

It can be seen that the technical solution provided by the present application replaces an ordinary disposable mask with a silicone face piece, for the silicone face piece, because it is very soft, it may be fitted to the face very well after wearing the mask, in such a way that a function of facial recognition can be realized and a mixing use of the mask can be avoided. Furthermore, the high fitting degree can also enhance the edge sealing effect. The breathing part is configured for exchanging with the outside air, in such a way that the face recognition high transparency food-grade silicone reusable mask can be reused, reducing the cost.

### BRIEF DESCRIPTION OF THE DRAWINGS

In order to illustrate the technical solutions in the embodiments of the present application more clearly, drawings used in the description of the embodiments will be briefly described below, obviously, the drawings in the following description are some embodiments of the present application, those of ordinary skill in the art can also obtain other drawings based on these drawings without any creative efforts.

FIG. 1 is a schematic structural diagram of a face recognition high transparency food-grade silicone reusable mask provided by an embodiment of the present application.

FIG. 2 is a schematic structural diagram of a breathing part disclosed by an embodiment of the present application.

FIG. 3 is a schematic structural diagram of another breathing part provided by an embodiment of the present application.

FIG. 4 is a schematic structural diagram of another face recognition high transparency food-grade silicone reusable mask provided by an embodiment of the present application.

### DESCRIPTION OF THE EMBODIMENTS

The technical solutions in the embodiments of the present application will be described clearly and completely in combination with the accompanying drawings in the embodiments of the present application, obviously, the described embodiments are a part of the embodiments of the present application, rather than all of the embodiments. Based on the embodiments of the present application, all other embodiments obtained by a person of ordinary skill in the art without creative efforts all belong to the scope of protection of the present application.

The terms, such as “first”, “second”, “third”, “fourth”, etc., in the specification, claims and the accompanying drawings of the present application are used to distinguish different objects, and are not intended to describe a specific order. Furthermore, the terms “comprise”, “have” and any variations thereof are intended to cover a non-exclusive inclusion. For example, a process, method, system, product, or device that comprises a series of steps or units is not limited to the listed steps or units, but alternatively comprises steps or units that are not listed, or alternatively comprises other steps or units inherent to these processes, methods, products or devices.

References to “an embodiment” herein mean that a particular feature, structure, or characteristic described in connection with the embodiments may be included in at least one embodiment of the present application. The appearances of the phrase in various places in the specification are not necessarily referring to the same embodiments, and are not exclusive or alternative embodiments that are mutually exclusive from other embodiments. Those skilled in the art will explicitly and implicitly understand that the embodiments described herein can be combined with other embodiments.

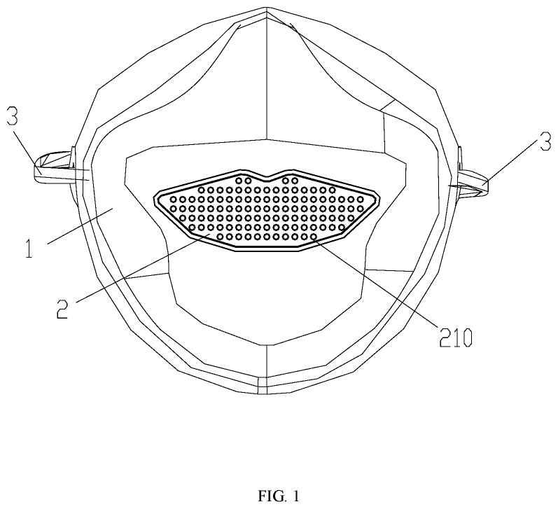

Referring to FIG. 1, FIG. 1 is a schematic structural diagram of a face recognition high transparency food-grade silicone reusable mask provided by an embodiment of the present application, as shown in FIG. 1, the mask comprises a silicone face piece 1, a breathing part 2 and a tightening part 3, wherein the breathing part 2 is arranged at a position of the mouth and nose, two ends of the tightening part 3 are respectively fixedly arranged with two edges of the silicone face piece 1, and the tightening part 3 is used for wearing the mask.

The technical solution provided by the present application replaces an ordinary disposable mask with a silicone face piece, for the silicone face piece, because it is very soft, it may be fitted to the face very well after wearing the mask, in such a way that a function of facial recognition can be realized and a mixing use of the mask can be avoided. Furthermore, the high fitting degree can also enhance the edge sealing effect. The breathing part 2 is configured for exchanging with the outside air, in such a way that the face recognition high transparency food-grade silicone reusable mask can be reused, reducing the cost.

Alternatively, in an alternative solution, the above-mentioned silicone face piece is a transparent food-grade silicone face piece.

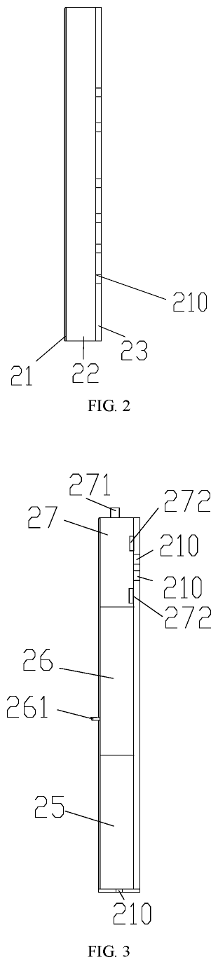

Alternatively, in another embodiment, referring to FIG. 2, the breathing part 2 may comprise a breathing cover 21, a cavity 22 and a mouth and nose part 23, the breathing cover is provided with a plurality of breathing holes 210, the cavity 22 is used to place a disposable mask matched with the size thereof, the mouth and nose part 23 is also provided with a plurality of breathing holes 210, the breathing cover 21 is buckled and fixed with the mouth and nose part 23, and the mouth and nose part 23 is formed in the middle of the breathing cover 21 and the mouth and nose part 23 after the breathing cover 21 is buckled and fixed with the mouth and nose part 23.

The breathing cover 21 is set in a buckle-fixed manner, in such a way that the user can place a disposable mask that matches the size of the cavity in the cavity 22. The disposable mask filters the air in the breathing part 2, due to other positions are sealed by the silicone face piece 1, the area of the disposable mask is greatly reduced and the material of the disposable mask is greatly reduced, in this way, the use cost of the mask can be reduced after reuse.

In an alternative embodiment, the above-mentioned tightening part 3 may be a tightening rope.

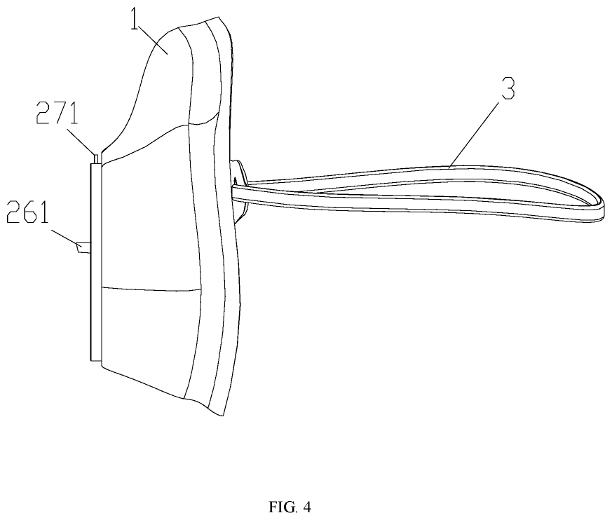

Referring to FIG. 3, FIG. 3 provides another breathing part of another structure. As shown in FIG. 3, the breathing part 2 may comprise a lower cavity body 25, a liquid cavity 26 and an upper cavity body 27, wherein the liquid cavity 26 is composed of PTFE permeable membrane, the liquid cavity 26 is provided with a discharge port 261, the lower cavity body 25 is communicated with the outside air, the side wall of the upper cavity body 27 is provided with a plurality of breathing holes 210 communicating with the mouth and nose, and the periphery of the upper cavity body 27 is also provided with a one-way ventilation valve 271 communicating with the outside.

The breathing part having the structure shown in FIG. 3 and FIG. 4 may realize a replaceable mask at a lower cost. For the liquid cavity 26, the liquid can be changed through the discharge port, such as 75% alcohol, disinfectant, etc. The principle is that after the outside air enters the lower cavity body 25, the air will penetrate the PTFE gas-permeable membrane (due to the characteristic of PTFE that PTFE is permeable to gas but not permeable to liquid) into the liquid cavity 26, in such a way that the outside air passes through the liquid cavity 26 for disinfection and enters the upper cavity body 27, thereby killing the novel coronavirus. The user inhales the air in the upper cavity body 27 by breathing, and the exhaled gas makes the pressure in the upper cavity body 27 increase, in such a way that the one-way ventilation valve 271 is pushed open, and the exhaled gas is discharged to the outside, thereby achieving air exchange. The technical solution of the present application can realize the disinfection effect by changing the liquid, which reduces the cost, and the mask can also be injected with water and other substances, which can prevent air pollutants such as smog.

In an alternative embodiment, the side wall of the upper cavity body 27 is further provided with an adsorption material 272, such as activated carbon or the like.

In the above-mentioned embodiments, the description of each embodiment has its own emphasis. For parts that are not described in detail in an embodiment, reference may be made to related descriptions of other embodiments.

The embodiments of the present application are described in detail above, specific examples are used herein to illustrate the principles and implementation of the present application, and the description of the above embodiments is merely used to help understand the method and core idea of the present application; meanwhile, for a person of ordinary skill in the art, based on the idea of the present application, there will be a change in the specific implementation and scope of application. In summary, the content of this specification should not be construed as a limitation to the present application.

What is claimed is:

1. A face recognition high transparency food-grade silicone reusable mask, comprising a silicone face piece, a breathing part and a tightening part, wherein the breathing part is arranged at a position corresponding to mouth and nose, two ends of the tightening part are respectively fixed onto two opposite edges of the silicone face piece.

2. The face recognition high transparency food-grade silicone reusable mask of claim 1, wherein the silicone face piece is a transparent food-grade silicone face piece.

3. The face recognition high transparency food-grade silicone reusable mask of claim 1, wherein the breathing part comprises a breathing cover, a cavity and a mouth and nose part, the breathing cover is provided with a plurality of breathing holes, the cavity is configured to place a disposable mask matched with the size thereof,
the mouth and nose part is provided with a plurality of breathing holes, the breathing cover is buckled and fixed with the mouth and nose part, and the mouth and nose part is formed in the middle of the breathing cover and the mouth and nose part after the breathing cover is buckled and fixed with the mouth and nose part.

4. The face recognition high transparency food-grade silicone reusable mask of claim 1, wherein the breathing part comprises a lower cavity body, a liquid cavity and an upper cavity body, wherein the liquid cavity is made of PTFE gas-permeable membrane, the liquid cavity is arranged between the lower cavity body and the upper cavity body; the liquid cavity is provided with a discharge port, the lower cavity body is communicated with the outside air, the side wall of the upper cavity body is provided with a plurality of breathing holes communicating with the mouth and nose, and the periphery of the upper cavity body is further provided with a one-way ventilation valve communicating with the outside.

5. The face recognition high transparency food-grade silicone reusable mask of claim 4, wherein the side wall of the upper cavity body is further provided with an adsorption material.

6. The face recognition high transparency food-grade silicone reusable mask of claim 4, wherein the liquid cavity is provided with 75% alcohol.

7. The face recognition high transparency food-grade silicone reusable mask of claim 5, wherein the adsorption material is activated carbon.
